(19) United States
(12) Patent Application Publication
(10) Pub. No.: US 2025/0150164 A1
(43) Pub. Date: May 8, 2025

(54) SERVICE COMMUNICATION CONTROL METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/838,109

(22) PCT Filed: Feb. 14, 2022
(86) PCT No.: PCT/CN2022/076243

§ 371 Date: Aug. 13, 2024

(51) Int. Cl. H04B 7/185

(52) U.S. Cl. CPC H04B 7/18526; H04B 7/18547; H04B 7/18565

(57) ABSTRACT

A method, apparatus, a communication device, and a storage medium for service communication control in a network, involving obtaining satellite coverage information of an area where user equipment (UE) is located. The service communication control is performed by: obtaining satellite coverage information of an area where a user equipment (UE) is located; and according to the satellite coverage information, determining whether to perform service communication with the UE.

### CROSS-REFERENCE TO RELATED APPLICATIONS

This application is a national stage of International Application No. PCT/CN2022/076243, filed on Feb. 14, 2022, which is hereby incorporated by reference in its entirety.

### TECHNICAL FIELD

The present disclosure relates to, but is not limited to, the field of wireless communication technologies, and in particular, to a service communication control method and apparatus, a communication device, and a storage medium.

### BACKGROUND

Service communication may be classified into service communication performed by user equipment (UE) and service communication performed by a server end or a communication peer end according to an initiator end.

If a satellite access provides network service for a UE, the satellite access may be affected by insufficient number of satellites in a satellite chain or discontinuous satellite beams, and thus signal coverage (or referred to as satellite signal coverage) provided to the ground may be discontinuous. That is, when the UE accesses a network through a satellite in a certain area, there is no satellite signal coverage in a specific time period.

Therefore, in a process that the UE accesses a network and launches a service, discontinuous coverage of satellite access needs to be considered. For example, the UE is configured to be in a sleep mode or a power saving mode when no satellite signal is covered, so as to save power consumption of the terminal, and when the satellite signal coverage is recovered, the UE is woken up from the sleep mode, and network connection is re-established or the service is re-launched.

For another example, when the network side needs to send downlink signaling or service data to the UE, it needs to determine whether the UE has satellite signal coverage at this moment.

When the area where the UE is located is under satellite signal coverage, the signaling or service data is sent to the UE.

When the area where the UE is located is not under satellite signal coverage, the network side needs to buffer the signaling or service data to be sent to the UE. When the satellite signal coverage to the UE is recovered, the signaling or service data is sent to the UE.

### SUMMARY

Embodiments of the present disclosure provide a service communication control method and apparatus, a communication device, and a storage medium.

A first aspect of the embodiments of the present disclosure provides a service communication control method, performed by a first network element, including:

obtaining satellite coverage information of an area where a user equipment (UE) is located; and

determining whether to perform service communication with the UE according to the satellite coverage information.

A second aspect of the embodiments of the present disclosure provides a service communication control method, performed by a second network element, including:

sending satellite coverage information of an area where a user equipment (UE) is located to a first network element, where the satellite coverage information is used by the first network element to determine to perform service communication with the UE when the area where the UE is located is covered by satellite signals.

A third aspect of the embodiments of the present disclosure provides a service communication control apparatus, including:

an obtaining module, configured to obtain satellite coverage information of an area where a user equipment (UE) is located; and

a determining module, configured to determine whether to perform service communication with the UE according to the satellite coverage information.

A fourth aspect of the embodiments of the present disclosure provides a service communication control apparatus, performed by a second network element, including:

a second sending module, configured to send satellite coverage information of an area where a user equipment (UE) is located to a first network element, where the satellite coverage information is used by the first network element to determine to perform service communication with the UE when the area where the UE is located is covered by satellite signals.

A fifth aspect of the embodiments of the present disclosure provides a communication device, including a processor, a transceiver, a memory, and an executable program stored on the memory and executable by the processor, where when the processor executes the executable program, the service communication control method according to the first aspect or the second aspect is implemented.

A sixth aspect of the embodiments of the present disclosure provides a computer storage medium, where the computer storage medium stores an executable program; and when the executable program is executed by a processor, the service communication control method according to the first aspect or the second aspect is implemented.

It should be understood that the above general description and the following detailed description are merely exemplary and explanatory, and do not limit the embodiments of the present disclosure.

### BRIEF DESCRIPTION OF DRAWINGS

The accompanying drawings, which are incorporated in and constitute a part of this specification, illustrate embodiments consistent with the present disclosure and together with the description serve to explain the principles of the embodiments of the present disclosure.

FIG. 1 is a schematic structural diagram of a wireless communication system according to an exemplary embodiment.

FIG. 2 is a schematic flowchart of a service communication control method according to an exemplary embodiment.

FIG. 3 is a schematic flowchart of a service communication control method according to an exemplary embodiment.

FIG. 4 is a schematic flowchart of a service communication control method according to an exemplary embodiment.

FIG. 5 is a schematic flowchart of a service communication control method according to an exemplary embodiment.

FIG. 6 is a schematic flowchart of a service communication control method according to an exemplary embodiment.

FIG. 7 is a schematic flowchart of a service communication control method according to an exemplary embodiment.

FIG. 8 is a schematic flowchart of a service communication control method according to an exemplary embodiment.

FIG. 9 is a schematic flowchart of a service communication control method according to an exemplary embodiment.

FIG. 10 is a schematic structural diagram of a service communication control apparatus according to an exemplary embodiment.

FIG. 11 is a schematic structural diagram of a service communication control apparatus according to an exemplary embodiment.

FIG. 12 is a schematic structural diagram of a communication device according to an exemplary embodiment.

### DETAILED DESCRIPTION

Exemplary embodiments will be described in detail herein, examples of which are illustrated in the accompanying drawings. Where the following description refers to the drawings, unless otherwise indicated, same numerals in different drawings indicate same or similar elements. The embodiments described in the following exemplary embodiments do not represent all embodiments consistent with the embodiments of the present disclosure. Rather, they are merely examples of apparatuses and methods consistent with some aspects of embodiments of the present disclosure.

The terminology used in the embodiments of the present disclosure is merely for the purpose of describing specific embodiments, and is not intended to limit the embodiments of the present disclosure. As used herein, the singular forms “a,” “an,” and “the” are also intended to include plural forms unless the context clearly indicates other meanings. It should also be understood that the term “and/or” as used herein refers to and encompasses any or all possible combinations of one or more associated listed items.

It should be understood that although the terms first, second, third, etc., may be used to describe various information in the embodiments of the present disclosure, this information should not be limited to these terms. These terms are only used to distinguish the same type of information from each other. For example, without departing from the scope of the embodiments of the present disclosure, the first information may also be referred to as second information, and similarly, the second information may also be referred to as first information. Depending on context, the word “if” as used herein may be interpreted as “when” or “upon” or “in response to determining”.

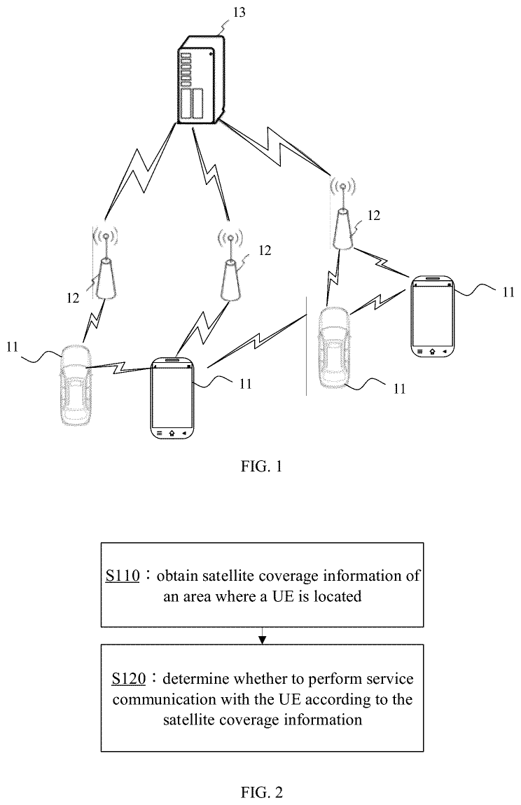

FIG. 1 is a schematic structural diagram of a wireless communication system according to an embodiment of the present disclosure. As shown in FIG. 1, a wireless communication system is a cellular mobile communication technology-based communication system, and the wireless communication system may include several user equipments (UE) 11 and several access devices 12.

The UE 11 may be a device that provides voice and/or data connectivity to a user. The UE 11 may communicate with one or more core networks through a radio access network (RAN), and the UE 11 may be an Internet of Things UE, such as a sensor device, a mobile phone (or referred to as a “cellular” phone), and a computer including the Internet of Things UE, for example, may be a fixed, portable, pocket, handheld, computer built-in, or in-vehicle apparatus. For example, a station (STA), a subscriber unit, a subscriber station, a mobile station, a mobile, a remote station, an access point, a remote terminal, an access terminal, a user terminal, a user agent, a user device, or a user equipment (UE). Alternatively, the UE 11 may be a device of an unmanned aerial vehicle. Alternatively, the UE 11 may be a vehicle-mounted device, for example, may be a vehicle computer including a wireless communication function, or a wireless communication device externally connected to a vehicle computer. Alternatively, the UE 11 may be a roadside device, for example, a street lamp, a signal light, or another roadside device having a wireless communication function.

The access device 12 may be a network-side device in a wireless communication system. The wireless communication system may be a 4th generation (4G) mobile communication system, also referred to as a long term evolution (LTE) system; or the wireless communication system may be a 5G system, also referred to as a new radio (NR) system or a 5G NR system. Alternatively, the wireless communication system may be a next generation system of the 5G system. The access network in the 5G system may be referred to as a new generation-radio access network (NG-RAN). Alternatively, a multi-channel communication (MTC) system.

The access device 12 may be an evolved access device (eNB) used in a 4G system. Alternatively, the access device 12 may be an access device (gNB) in a centralized distributed architecture in a 5G system. When the access device 12 adopts a centralized distributed architecture, the access device 12 usually includes a central unit (CU) and at least two distributed units (DU). The centralized unit is provided with a protocol stack of a Packet Data Convergence Protocol (PDCP) layer, a Radio Link Control (RLC) layer, and a Media Access Control (MAC) layer; and the distributed unit is provided with a protocol stack of a Physical (PHY) layer, which is not limited in the embodiments of the present disclosure.

A wireless connection may be established between the access device 12 and the UE 11 through a wireless air interface. In different implementations, the wireless air interface is a wireless air interface based on a fourth generation mobile communication network technology (4G) standard; or the wireless air interface is a wireless air interface based on a fifth generation mobile communication network technology (5G) standard, for example, the wireless air interface is a new air interface; or the wireless air interface may also be a wireless air interface based on a next generation mobile communication network technology standard after 5G.

The embodiments of the present disclosure provide a service communication control method, which is executed by a first network element, and includes following steps: determining to perform service communication with a UE when an area where the UE is located is covered by satellite signals.

Illustratively, as shown in FIG. 2, an embodiment of the present disclosure provides a service communication control method, where the method is performed by a first network element, and the method includes: S110, obtaining satellite coverage information of an area where a UE is located.

S120, determining whether to perform service communication with the UE according to the satellite coverage information.

The first network element may include an application function (AF). The application function may correspond to one or more application servers.

The UE is a UE in a discontinuous coverage scenario. The discontinuous coverage scenario refers to the area where the UE is located being covered by satellite signals in some periods and not by satellite signals in others.

A type of the UE may include various types of UEs, for example, the UE may be various IoT terminals or industrial sensors. The IoT terminal includes, but is not limited to, smart home devices and/or smart office devices, etc.

The satellite coverage information may be various types of information that can be used by the first network element to determine whether there is satellite signal coverage, a time period when there is satellite signal coverage, or a time period when there is no satellite signal coverage in an area in which the UE that needs to perform service communication is located.

For example, the satellite coverage information may be determined based on ephemeris information of a satellite and location information of the UE. The location information of the UE may be determined by using satellite positioning, or may be determined based on a location of an access network device that establishes a connection to the UE. Certainly, this is merely an example of a manner of determining location information of an area where the UE is located, and actual implementation is not limited to this example.

The network element of the network side may confirm the satellite coverage information of the area where the UE is located when the UE performs initial registration with the network, performs registration update, or performs a service request. Subsequently, the satellite coverage information of the area where the UE is located may be updated according to the change of the area where the UE is located and the ephemeris information, and the related network element or the UE may be notified in time.

The first network element may receive the satellite coverage information from a core network element or receive the satellite coverage information from a capability exposure network element.

After the satellite coverage information is obtained, whether to perform service communication with the UE is determined according to the satellite coverage information, instead of directly performing service communication with the UE when there is a service communication requirement.

In some embodiments, whether the area where the UE is located is covered by satellite signals may be determined by the first network element, or may be notified by another network element. For example, when the first network element is the AF, a network element that notifies the first network element whether the area where the UE is located is covered by satellite signals may be a second network element such as a Policy Control Function (PCF) or an Access Management Function (AMF). The second network element may be a network element storing the satellite coverage information of the UE. For example, the second network element may further be an authorized network element for the service communication performed between the first network element and the UE. When receiving a service authorization requested by the first network element to perform service communication with the UE, the second network element may determine, according to the satellite coverage information, whether to perform service authorization for the first network element, and when there is no satellite signal coverage in the area where the UE is located, the second network element may reject the service authorization, and similarly, only when there is satellite signal coverage in the area where the UE is located, the first element is enabled to perform the service communication with the UE.

Illustratively, S120 may include:

in response to determining, according to the satellite coverage information, that the area where the UE is located is covered by satellite signals, determining to perform the service communication with the UE;

and/or,

in response to determining, according to the satellite coverage information, that the area where the UE is located is not covered by satellite signals, determining not to perform the service communication with the UE.

In this way, on the one hand, the AF does not perform service communication with the UE when there is no satellite signal coverage in the area where the UE is located, thereby reducing network side buffer overheads caused by absence of satellite signal coverage, and alleviating network congestion caused by simultaneous transmission of a large amount of data when network connection is recovered.

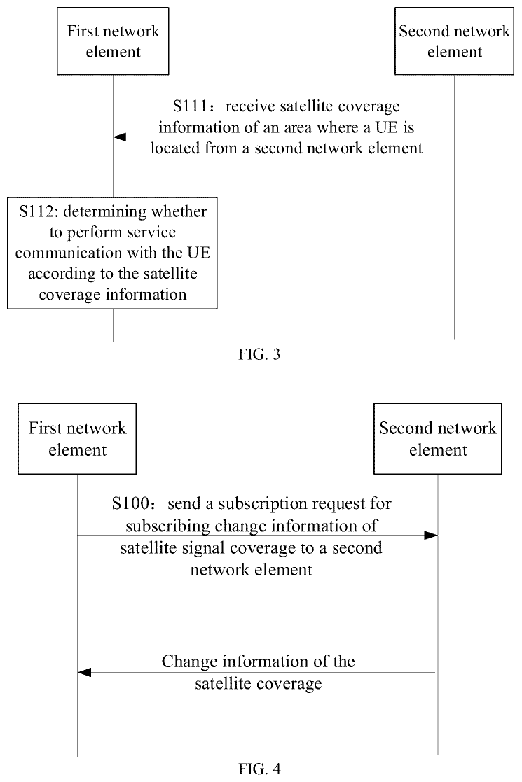

In some embodiments, as shown in FIG. 3, an embodiment of the present disclosure provides a service control method, performed by a first network element, and the method may include:

S111, receiving satellite coverage information of an area where a UE is located from a second network element.

S112, determining whether to perform service communication with the UE according to the satellite coverage information.

For example, S112 may include: when there is satellite coverage in the area where the UE is located, determining to allow the first network element to perform service communication with the UE, and/or when there is no satellite signal coverage in the area where the UE is located, determining not to allow the first network element to perform service communication with the UE.

In some embodiments, the second network element includes but is not limited to a core network element such as a policy control function (PCF). In some other embodiments, the second network element may further include but is not limited to an access management function (AMF).

In some embodiments, the satellite coverage information includes:

time period information of satellite signal coverage in the area where the UE is located;

or,

change information of satellite signal coverage of the area where the UE is located.

The time period information may explicitly indicate a time period when the area where the UE is located is covered by satellite signals, or a time period when the area where the UE is located is not covered by satellite signals. When the time period information indicates the time period when the area where the UE is located is not covered by satellite signals, the time period when the area where the UE is located is covered by satellite signals is any time period other than the time period when the area where the UE is located is not covered by satellite signals.

The change information may indicate change between the area where the UE is located being covered by satellite signals and not being covered by satellite signals, so that a time period when the area where the UE is located is covered by satellite signals may be determined according to the change information of two consecutive times.

The change information may include one or more bits indicating two cases: the area where the UE is located changes from being covered by satellite signals to not being covered by satellite signals, or the area where the UE is located changes from not being covered by satellite signals to being covered by satellite signals, which has characteristics of small overhead of signaling bit.

In some embodiments, the time period information of satellite signal coverage includes:

start time information and duration information when the area where the UE is located is covered by satellite signals; or start time information and end time information when the area where the UE is located is covered by satellite signals;

and/or,

start time information and duration information when the area where the UE is located is not covered by satellite signals; or start time information and end time information when the area where the UE is located is not covered by satellite signals.

In some other embodiments, the time period information further includes: offset duration information when the area where the UE is located changes from being covered by satellite signals to not being covered by satellite signals, or offset duration information when the area where the UE is located changes from not being covered by satellite signals to being covered by satellite signals.

In conclusion, the time period information of the satellite signal coverage may directly indicate a time period when the area where the UE is located is covered by satellite signals, and/or a time period when the area where the UE is located is not covered by satellite signals, which is not limited to the above examples.

In some embodiments, the time period information is requested by the first network element from the second network element, or pushed by the second network element to the first network element regularly or when a predetermined trigger event is satisfied.

For example, when detecting that the satellite signal coverage of the area where the UE is located changes, the second network element determines that a predetermined trigger event is detected, and actively sends the satellite coverage information to the first network element.

For another example, after the first network element establishes the connection to the second network element, the second network element provides the satellite coverage information to the first network element.

For another example, to reduce information transmission between the first network element and the second network element, when the first network element needs to perform a service communication with the UE, the first network element sends a service authorization request to the second network element, and when receiving the service authorization, the second network element sends the time period information when the area where the UE is located is covered by satellite signals to the first network element, and in this way, the first network element will receive the satellite coverage information after sending the service authorization request.

In some embodiments, the change information of satellite signal coverage includes:

first change information, indicating that the area where the UE is located changes from being covered by satellite signals to not being covered by satellite signals;

and/or,

second change information, indicating that the area where the UE is located changes from not being covered by satellite signals to being covered by satellite signals.

The two types of change information may respectively indicate different cases of satellite signal coverage of the area where the UE is located.

When the change information includes only the first change information, and when the first network element does not receive the first change information, it may be determined by default that the area where the UE is located is covered by satellite signals.

When the change information includes only the second change information, and when the first network element does not receive the second change information, it may be determined by default that the area where the UE is located is not covered by satellite signals.

In some embodiments, the change information may be received from the second network element in an event notification.

In some embodiments, as shown in FIG. 4, an embodiment of the present disclosure provides a service control method, performed by a first network element, and the method may include:

S100, sending a subscription request for subscribing change information of satellite signal coverage to a second network element.

After the subscription request is sent, the second network element sends the change information to the first network element once satellite signal coverage change in the area where the UE is located is detected within an effective time range of the subscription request.

The effective time range may be indicated by time information carried in the subscription request, or a time range after the subscription request is sent and before an unsubscription request is sent is determined as the effective time range. The unsubscription request may be a request for the second network element to unsubscribe the change information.

In some other embodiments, the effective time range may be a time range when the UE is in a discontinuous coverage scenario. The discontinuous coverage scenario refers to that the area where the UE is located is covered by satellite signals in some time periods, and is not covered by satellite signals in some other time periods.

As shown in FIG. 5, an embodiment of the present disclosure provides a service communication control method, performed by a first network element, and including:

S210: in response to determining, according to satellite coverage information, that an area where a UE is located is covered by satellite signals, performing service communication with the UE;

and/or,

S220: in response to determining, according to satellite coverage information, that an area where a UE is located is not covered by satellite signals, stopping performing service communication with the UE.

The service communication control method may be performed separately, and may be performed in combination with any one of the foregoing embodiments.

Performing service communication with the UE herein may include: a process of establishing a communication link for communicating with the UE and a process of exchanging service data based on the established communication link.

When it is determined, according to the satellite coverage information, that there is satellite coverage in the area where the UE is located, service communication between the first network element and the UE is performed, that is, a process of establishing a communication link between the first network element and the UE is entered, and since network resources are consumed when the communication link is established, network resource consumption caused by establishing the communication link when there is no satellite coverage in the area where the UE is located can be reduced, buffering of service data sent by the network device to the UE by the first network element can also be reduced, and network overheads are reduced.

In some embodiments, performing service communication with the UE may include:

performing a service authorization request to a second network element;

after receiving a service authorization success instruction, the first network element determines to start to perform service communication with the UE within a time period when the area where the UE is located is covered by satellite signals, otherwise, the first network element does not start to perform service communication with the UE.

In some embodiments, the area where the UE is located includes:

a tracking area (TA) where the UE is located;

or,

a satellite cell where the UE is located.

The above is a specific example of the area where the UE is located, and specific implementations are not limited to the above example.

In some embodiments, the area where the UE is located may further include: cells indicated by cell identifiers included in a cell list where the UE is located. The cell identifiers in the cell list may include: a cell identifier of a serving cell where the UE is currently located and cell identifiers of one or more neighboring cells of the serving cell.

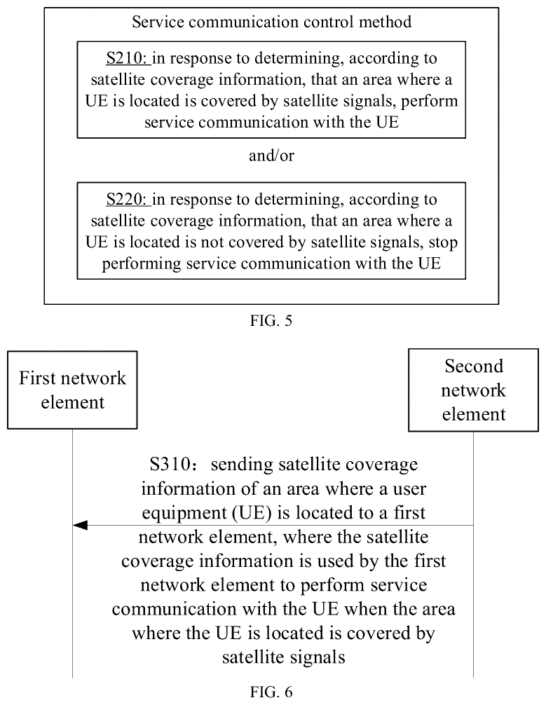

As shown in FIG. 6, an embodiment of the present disclosure provides a service communication control method, performed by a second network element, including:

S310: sending satellite coverage information of an area where a user equipment (UE) is located to a first network element, where the satellite coverage information is used by the first network element to perform service communication with the UE when the area where the UE is located is covered by satellite signals.

The second network element herein may be a core network element and/or a network capability exposure function (NEF). For example, the second network element includes but is not limited to a PCF, an AMF, an NEF, or the like.

The second network element sends the satellite coverage information to the first network element, so that the first network element can perform service communication with the UE only when there is satellite signal coverage in the area where the UE is located, thereby reducing network overheads generated when the network side buffers the service communication data when there is no satellite signal coverage in the area where the UE is located.

Illustratively, the satellite coverage information includes:

time period information of satellite signal coverage in the area where the UE is located;

or,

change information of satellite signal coverage of the area where the UE is located.

The time period information may explicitly indicate a time period when the area where the UE is located is covered by satellite signals, or a time period when the area where the UE is located is not covered by satellite signals. When the time period information indicates the time period when the area where the UE is located is not covered by satellite signals, the time period when the area where the UE is located is covered by satellite signals is any time period other than the time period when the area where the UE is located is not covered by satellite signals.

The change information may indicate change between the area where the UE is located being covered by satellite signals and not being covered by satellite signals, so that a time period when the area where the UE is located is covered by satellite signals may be determined according to the change information of two consecutive times.

The change information may include one or more bits indicating two cases: the area where the UE is located changes from being covered by satellite signals to not being covered by satellite signals, or the area where the UE is located changes from not being covered by satellite signals to being covered by satellite signals, which has characteristics of small overhead of signaling bit.

In some embodiments, the method includes:

receiving a service authorization request;

sending the time period information to the first network element after receiving the service authorization request.

For example, when the first network element needs to perform service communication to the UE or receive a service communication call of the communication peer to the UE, the first network element sends a service authorization request carrying at least identification information of the UE to the second network element. After receiving the service authorization request, the second network element determines, based on the identification information of the UE, satellite coverage information of the area where the UE is located.

The identification information of the UE includes, but is not limited to: an International Mobile Subscriber Identity (IMSI), an International Mobile Equipment Identity (IMEI), or a Temporary Mobile Subscriber Identity (TMSI) of the UE. Certainly, this is merely an example of the identification information of the UE.

Further, sending the time period information to the first network element after receiving the service authorization request includes:

sending the time period information to the first network element after receiving the service authorization request and determining to reject the service authorization.

Certainly, in some embodiments, S310 may include:

sending the satellite coverage information to the first network element according to a sending time interval; and

sending the satellite coverage information to the first network element when a predetermined trigger event is detected.

The sending time interval may include: a sending period for periodically sending the satellite coverage information, or a predetermined sending interval for aperiodically sending the satellite coverage information.

The predetermined trigger event includes but is not limited to: when detecting that a satellite signal coverage condition of the area where the UE is located changes, and/or when the UE switches from a continuous coverage scenario to a discontinuous coverage scenario, sending the satellite coverage information to the first network element.

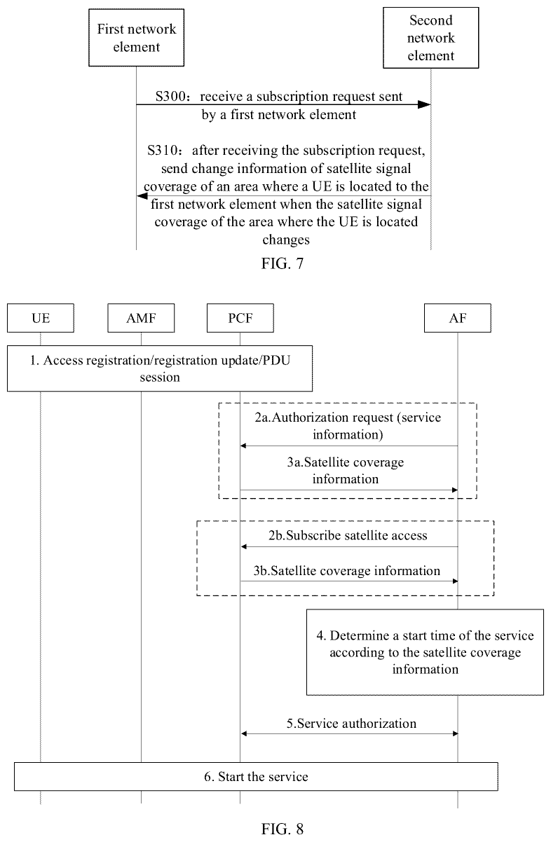

In some embodiments, as shown in FIG. 7, the method further includes:

S300, receiving a subscription request sent by a first network element.

S310 may include: after receiving the subscription request, sending change information of satellite signal coverage of an area where a UE is located to the first network element when the satellite signal coverage of the area where the UE is located changes.

The change information may be sent based on the subscription request, so that after receiving the subscription request from the first network element, the second network element monitors a change of satellite signal coverage of the area where the UE is located, and in response to detecting that the satellite signal coverage of the area where the UE is located changes, the second network element actively sends the change information to the first network element.

After receiving the subscription request, the second network element sends the change information to the first network element once satellite signal coverage change in the area where the UE is located is detected within an effective time range of the subscription request.

The subscription request may include identification information of the UE, and the identification information of the UE is used by the first network element to notify the second network element to subscribe the satellite coverage information of the area where the UE is located.

The effective time range may be indicated by time information carried in the subscription request, or a time range after the subscription request is received and before an unsubscription request is received is determined as the effective time range. The unsubscription request may be a request of the first network element to unsubscribe the change information.

In some other embodiments, the effective time range may be a time range when the UE is in a discontinuous coverage scenario. The discontinuous coverage scenario refers to the area where the UE is located being covered by satellite signals in some time periods and not covered by satellite signals in some other time periods.

The service communication control method provided in this embodiment may include: determining, by the second network element based on the satellite coverage information of the area where the UE is located, whether the area where the UE is located is covered by satellite signals, and notifying the first network element of a determination result, where the determination result is used by the first network element to perform service communication with the UE when the area where the UE is located is covered by satellite signals. For example, the determination result may be dedicated signaling or indication bits.

The service communication control method provided in this embodiment may include: determining, by the second network element based on the satellite coverage information of the area where the UE is located, whether the area where the UE is located is covered by satellite signals; and controlling, based on a determination result, service communication between the first network element and the UE. For example, the second network element sends a control instruction to the first network element to control whether the first network element is allowed to perform service communication with the UE, or when service authorization is performed on the first network element, sends a service authorization success instruction to the first network element only when the area where the UE is located is covered by satellite signals, or sends a service authorization failure instruction to control the first network element to perform service communication with the UE only when the area where the UE is located is covered by satellite signals. Illustratively, the time period information of the satellite signal coverage includes:

start time information and duration information when the area where the UE is located is covered by satellite signals; or start time information and end time information when the area where the UE is located is covered by satellite signals;

and/or,

start time information and duration information when the area where the UE is located is not covered by satellite signals; or start time information and end time information when the area where the UE is located is not covered by satellite signals.

Illustratively, the change information of the satellite signal coverage includes:

first change information, indicating that the area where the UE is located changes from being covered by satellite signals to not being covered by satellite signals;

or,

second change information, indicating that the area where the UE is located changes from not being covered by satellite signals to being covered by satellite signals.

The area where the UE is located includes:

a tracking area (TA) where the UE is located;

or,

a satellite cell where the UE is located.

In some embodiments, the method further includes:

receiving a service authorization request sent by the first network element;

when service communication between the first network element and the UE is allowed, sending a service authorization success instruction to the first network element, where the service authorization success instruction is used by the first network element to determine to start the service communication with the UE.

For example, when receiving the service authorization request, the second network element determines, based on a current network resource and Quality of Service (QOS) required by a service indicated by the service authorization request, whether to allow service communication between the first network element and the UE.

In some embodiments, the method further includes:

when determining that service communication between the first network element and the UE is not allowed, sending a service authorization failure instruction to the first network element. The first network element stops service communication with the UE.

In a communication process between the UE and the network, if there is discontinuous coverage of satellite signals, data sent by the network side to the UE needs to be buffered when there is no satellite signal coverage, and then the data is sent to the UE when it is determined that the satellite signal coverage is recovered. However, if there is no satellite signal coverage in a specific area (for example, one tracking area (TA)) for a time period, a network element (for example, an AMF, SMF) of the network side receives and buffers a large amount of data that needs to be sent to the UE in the area, and once the satellite signal coverage in the area where the UE is located is recovered, the network side and all UEs in the area need to establish network connections and send data. Due to reasons such as a large delay and limited bandwidth for the satellite access, once the signal coverage of the area is recovered, a large amount of data is sent to the UE in the area instantaneously through the satellite access, which may cause network congestion, may seriously affect service experience, and even cause data loss.

In order to alleviate the problem of network congestion caused by instantaneous mass data transmission due to satellite signal recovery, one possible way is to reduce the data buffer at the network side as much as possible in the time period without satellite signal coverage, which requires some services to be performed as less as possible in the time period without satellite signal coverage. For example, data transmission of some IoT services may be regularly triggered, and when satellite access is used and in a case of discontinuous coverage, satellite coverage condition needs to be referred to, and transmission needs to be triggered when there is satellite coverage.

The embodiments of the present disclosure provide a service optimization method in a case of discontinuous satellite coverage, which is used for a service performed by a service server or a communication peer end, it is determined whether to launch the service according to a satellite coverage condition through an application function, so as to reduce a problem of network congestion caused by a large amount of data buffering and signal coverage at a network side due to initiation of the service in a case of absence of satellite signal coverage.

The application function obtains satellite coverage information, and determines whether to start service communication according to the satellite coverage information.

The application function may obtain the satellite coverage information from a second network element (e.g., PCF). A time and a coverage duration of satellite signal coverage and/or a time and a non-coverage duration of absence of satellite signal coverage for a specific area (for example, a TA or a satellite cell) can be determined according to the satellite coverage information.

Alternatively, the application function obtains the satellite coverage information by using an event subscription mechanism includes that:

the application function subscribes an event of a satellite coverage change from a second network element (for example, a PCF), and requests to report an event when presence of satellite signal coverage changes to absence of satellite signal coverage, or to report an event when absence of satellite signal coverage changes to presence of satellite signal coverage;

the second network element reports satellite coverage information to the application function after receiving a satellite coverage change (presence of coverage changes to absence of coverage, or absence of coverage changes to presence of coverage), where the satellite coverage information is the above corresponding event.

The application function (AF) determines whether to start service communication according to the satellite coverage information may include that:

the application function (AF) determines a coverage time period of satellite signals according to the satellite coverage information, and starts a service and interacts with the PCF within the coverage time period of satellite signals.

The application function (AF) determines whether to start service communication according to the satellite coverage information may include: when the satellite coverage information indicates that the presence of satellite signal coverage changes to absence of satellite signal coverage, the application function stops service communication; or when the satellite coverage information indicates that the absence of satellite signal coverage changes to presence of satellite signal coverage, the application function starts the service communication.

The UE accesses the 5G network through the satellite, and the network side obtains the satellite coverage information and provides the satellite coverage information to the AF. The AF determines a service communication start time based on the satellite coverage information, where the second network element may be a PCF, and an implementation process is shown in FIG. 8.

1. After a UE accesses to a network through a satellite, and an initial access registration succeeds, an AMF obtains satellite coverage information of an area where the UE is located, and provides the satellite coverage information to a PCF. A time and duration when an access position of the UE is covered by satellite signals, and a time and duration when the access position of the UE is not covered by satellite signals can be determined according to the satellite coverage information. When satellite coverage is adjusted, latest satellite coverage information may be provided to the AMF in a registration update procedure, a protocol data unit (PDU) session establishment procedure, and a PDU session modification procedure, etc., and the AMF correspondingly provides the latest satellite coverage information to the PCF.

2a. the AF launches a service, and performs a service authorization request to the PCF.

3a. the PCF determines, according to the satellite coverage information, that the UE is currently in a non-signal coverage time, and returns a service authorization failure to the AF, and provides the satellite coverage information of the UE to the AF.

Alternatively,

2b. before launching the service, the AF subscribes an access type from the PCF, and in response to the access type being satellite access, the AF subscribes the satellite coverage information from the PCF.

3b. the PCF returns the satellite coverage information to the AF.

4. after obtaining the satellite coverage information, the AF determines a time and a duration when the UE is covered by satellite signals based on the satellite coverage information.

5. the AF prepares to start a service at the time of satellite signal coverage, and performs a service authorization request to the PCF.

6. the PCF performs QoS authorization on the service, and issues the service to the SMF and a user plane function (UPF) for execution.

7. the AF performs the service to the UE.

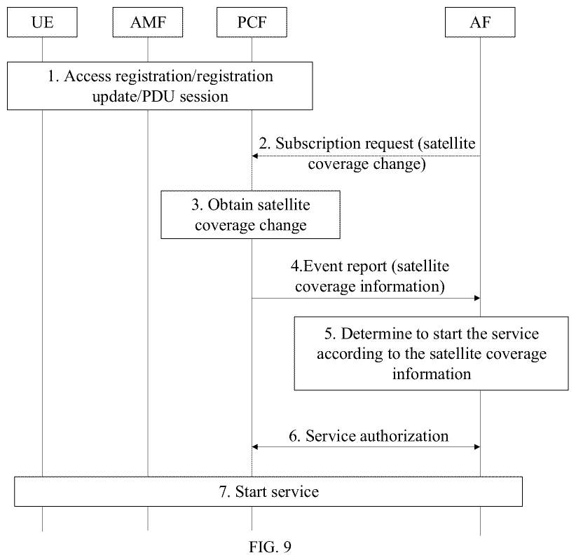

When a UE accesses a 5G network through a satellite, the network obtains satellite coverage information and stores the satellite coverage information in a context corresponding to the UE. The AF subscribes a satellite coverage change event from the network, and through an event reporting mechanism, the AF may learn whether the UE is in satellite signal coverage, so as to determine whether to start service communication. The second network element may be a PCF, and an implementation process thereof is shown in FIG. 9.

1. after a UE accesses a network through a satellite, and an initial access registration succeeds, an AMF obtains satellite coverage information and provides the satellite coverage information to a PCF. A time period when an access position of the UE is covered by satellite signals, and/or a time period when the access position of the UE is not covered by satellite signals can be determined according to the satellite coverage information. When satellite signal coverage is adjusted, latest satellite coverage information may be provided to the AMF in a registration update procedure, a protocol data unit (PDU) session establishment procedure, and a PDU session modification procedure, etc., and the AMF correspondingly provides the latest satellite coverage information to the PCF. Further, the AMF correspondingly provides the satellite coverage information to the PCF.

2. the AF subscribes an event of satellite coverage change from the PCF, and when satellite signal coverage changes (from presence of coverage to absence of coverage, or from absence of coverage to presence of coverage), a corresponding event is required to be reported.

3. the PCF obtains a satellite coverage change event. The PCF may determine, based on the satellite coverage information of the UE obtained from the AMF, when the UE is in satellite signal coverage, and when the UE is not in satellite signal coverage. Alternatively, the PCF subscribes a satellite coverage change event from another network element (for example, an AMF or an SMF). When the satellite coverage changes, the PCF receives the satellite coverage change event and the satellite coverage/non-coverage information that are reported by the another network element.

4. When the PCF determines that the presence of satellite coverage changes to absence of satellite coverage, the PCF reports the satellite coverage change event to the AF, and indicates that the satellite coverage information is absence of satellite signal coverage, or determines that presence of the satellite signal coverage changes to absence of the satellite signal coverage, and the PCF reports the satellite coverage change event to the AF, and indicates that the satellite coverage information is presence of satellite signal coverage.

5. the AF receives the satellite coverage change event report information from the PCF, and stops the service communication when the received satellite coverage information indicates absence of satellite signal coverage. When the received satellite coverage information indicates presence of satellite coverage, the AF may start service communication with the UE.

6. When the AF starts service communication with the UE, the AF requests the PCF for service authorization.

7. the PCF performs QoS authorization on the service, and issues to the SMF; and the UPF performs QoS authorization to establish a communication link for service communication between the AF and the UE. The AF performs the service to the UE.

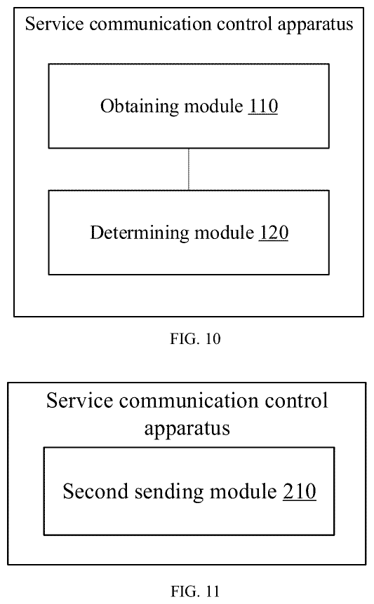

As shown in FIG. 10, an embodiment of the present disclosure provides a service communication control apparatus, including:

an obtaining module 110, configured to obtain satellite coverage information of an area where a user equipment (UE) is located; and

a determining module 120, configured to determine whether to perform service communication with the UE according to the satellite coverage information.

The service communication control apparatus is included in a first network element.

In some embodiments, the obtaining module 110 and the determining module 120 include program modules; and after the program modules are executed by a processor, obtaining of the satellite coverage information of the area where the UE is located and control of the service communication between the first network element and the UE can be implemented.

In some other embodiments, the obtaining module 110 and the determining module 120 include a software and hardware combination module; the software and hardware combination module includes but is not limited to a programmable array; and the programmable array includes but is not limited to a field programmable array and/or a complex programmable array.

In some other embodiments, the obtaining module 110 and the determining module 120 may be hardware-only modules; and the hardware-only modules may include, but are not limited to, application-specific integrated circuits.

In some embodiments, the obtaining module 110 is configured to receive the satellite coverage information of the area where the UE is located from a second network element.

where the satellite coverage information includes:

time period information of satellite signal coverage in the area where the UE is located;

or,

change information of satellite signal coverage of the area where the UE is located.

In some embodiments, the time period information of satellite signal coverage includes:

start time information and duration information when the area where the UE is located is covered by satellite signals; or start time information and end time information when the area where the UE is located is covered by satellite signals;

and/or,

start time information and duration information when the area where the UE is located is not covered by satellite signals; or start time information and end time information when the area where the UE is located is not covered by satellite signals.

In some embodiments, the change information of satellite signal coverage includes:

first change information, indicating that the area where the UE is located changes from being covered by satellite signals to not being covered by satellite signals;

and/or,

second change information, indicating that the area where the UE is located changes from not being covered by satellite signals to being covered by satellite signals.

In some embodiments, the apparatus further includes:

first sending module, configured send a subscription request for subscribing change information of the satellite signal coverage to the second network element.

In some embodiments, the determining module 120 is configured to: in response to determining, according to the satellite coverage information, that the area where the UE is located is covered by satellite signals, perform the service communication with the UE.

In some embodiments, the determining module 120 is configured to: perform a service authorization request to the second network element; and determine to start service communication with the UE when receiving a service authorization success instruction sent by the second network element.

In some embodiments, the first network element includes an application function (AF);

and/or,

the second network element includes a policy control function (PCF).

In some embodiments, the area where the UE is located includes:

a tracking area (TA) where the UE is located;

or,

a satellite cell where the UE is located.

As shown in FIG. 11, an embodiment of the present disclosure provides a service communication control apparatus, including:

a second sending module 210, configured to send satellite coverage information of an area where a user equipment (UE) is located to a first network element, where the satellite coverage information is used by the first network element to perform service communication with the UE when the area where the UE is located is covered by satellite signals.

The service communication control apparatus is included in a second network element.

In some embodiments, the second sending module 210 may include a program module, and after the program module is executed by a processor, the satellite coverage information of the area where the UE is located can be sent to the first network element.

In some other embodiments, the second sending module 210 may include a software and hardware combination module; and the software and hardware combination module includes but is not limited to a programmable array.

In some other embodiments, the second sending module 210 may also be a hardware-only module, and the hardware-only module includes but is not limited to an application-specific integrated circuit.

In some embodiments, the satellite coverage information includes:

time period information of satellite signal coverage in the area where the UE is located;

or,

change information of satellite signal coverage of the area where the UE is located.

In some embodiments, the apparatus further includes:

a first receiving module, configured to receive a subscription request sent by the first network element;

the second sending module 210, configured to: after receiving the subscription request, send change information of satellite signal coverage of the area where the UE is located to the first network element when the satellite signal coverage of the area where the UE is located changes.

In some embodiments, the time period information of satellite signal coverage includes:

start time information and duration information when the area where the UE is located is covered by satellite signals; or start time information and end time information when the area where the UE is located is covered by satellite signals;

and/or,

start time information and duration information when the area where the UE is located is not covered by satellite signals; or start time information and end time information when the area where the UE is located is not covered by satellite signals.

In some embodiments, the change information of satellite signal coverage includes:

first change information, indicating that the area where the UE is located changes from being covered by satellite signals to not being covered by satellite signals;

and/or,

second change information, indicating that the area where the UE is located changes from not being covered by satellite signals to being covered by satellite signals.

In some embodiments, the area where the UE is located includes:

a tracking area (TA) where the UE is located;

or,

a satellite cell where the UE is located.

In some embodiments, the apparatus further includes:

a second receiving module, configured to receive a service authorization request sent by the first network element;

the first sending module is further configured to: when service communication between the first network element and the UE is allowed, send a service authorization success instruction to the first network element, where the service authorization success instruction is used by the first network element to determine to start the service communication with the UE.

An embodiment of the present disclosure provides a communication device, including:

a memory for storing a processor-executable instruction;

a processor, connected to the memory;

the processor is configured to perform the service communication control method provided in any one of the above technical solutions.

The processor may include various types of storage medium, which are non-transitory computer storage medium, capable of continuing to memorize information stored thereon after the communication device is powered down.

Herein, the communication device includes: a network element, and the network element may be any one of the first network element and the second network element.

The processor may be connected to the memory by using a bus or the like, and is configured to read an executable program stored in the memory, for example, at least one of the methods shown in FIG. 2 to FIG. 9.

Embodiments of the present disclosure provide a computer storage medium, where the computer storage medium stores an executable program; after the executable program is executed by a processor, the service communication control method provided by any of the above technical solutions can be implemented; for example, after the executable program is executed by a processor, any one or more technical solutions of the service communication control method executed by a first network element and/or a second network element can be implemented.

The computer storage medium may be a non-transitory computer readable storage medium. For example, the non-transitory computer-readable storage medium may be a read-only memory (ROM), random access memory (RAM), CD-ROM, magnetic tape, floppy disk, optical data storage device, or the like.

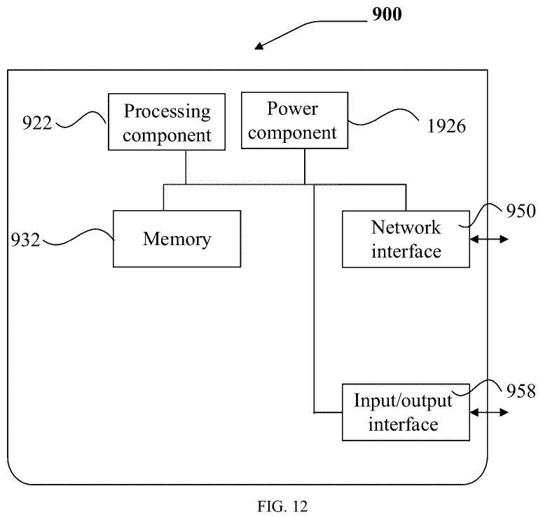

As shown in FIG. 12, an embodiment of the present disclosure shows a structure of a communication device. For example, the communication device 900 may be provided as any of the above network elements. The communication device may be specifically the first network element and/or the second network element.

Referring to FIG. 12, the communication device 900 includes a processing component 922, which further includes one or more processors, and a memory resource represented by a memory 932 for storing instructions executable by the processing component 922, such as an application program. The application program stored in the memory 932 may include one or more modules each corresponding to a set of instructions. In addition, the processing component 922 is configured to execute instructions to perform any method applied to the access device in the above method, for example, the method shown in any one of FIG. 2 to FIG. 9.

The communication device 900 may further include a power component 926 configured to perform power management of the communication device 900, a wired or wireless network interface 950 configured to connect the communication device 900 to a network, and an input/output (I/O) interface 958. The communication device 900 may operate based on an operating system stored in the memory 932, such as Windows Server™, Mac OS X™, Unix™, Linux™, FreeBSD™, or the like.

Other embodiments of the present disclosure will be readily apparent to those skilled in the art upon consideration of the specification and practice of the present disclosure disclosed herein. The present disclosure is intended to cover any changes, uses, or adaptations of the present disclosure that follow the general principles of the present disclosure and include common knowledge or conventional technical means in the art not disclosed in the present disclosure. The specification and examples are to be regarded as exemplary only, and the true scope and spirit of the present disclosure are indicated by the following claims.

It should be understood that the present disclosure is not limited to the precise structure already described above and shown in the drawings, and that various modifications and changes may be made without departing from the scope thereof. The scope of the present disclosure is limited only by the appended claims.

1. A method for service communication control, performed by a first network element, the method comprising:
obtaining satellite coverage information of an area where a user equipment (UE) is located;
determining whether to perform service communication with the UE according to the satellite coverage information.

2. The method according to claim 1, wherein obtaining the satellite coverage information of the area where the UE is located comprises:
receiving the satellite coverage information of the area where the UE is located from a second network element; wherein the satellite coverage information comprises:
time period information of satellite signal coverage in the area where the UE is located, or
change information of the satellite signal coverage of the area where the UE is located.

3. The method according to claim 2, wherein the time period information of the satellite signal coverage comprises at least one of:
start time information and duration information when the area where the UE is located is covered by satellite signals, or
start time information and end time information when the area where the UE is located is covered by the satellite signals,
or
start time information and duration information when the area where the UE is located is not covered by the satellite signals; or start time information and end time information when the area where the UE is located is not covered by the satellite signals.

4. The method according to claim 2, wherein the change information of the satellite signal coverage comprises at least one of:
first change information, indicating that the area where the UE is located changes from being covered by satellite signals to not being covered by satellite signals,
or
second change information, indicating that the area where the UE is located changes from not being covered by satellite signals to being covered by satellite signals.

5. The method according to claim 2, further comprising:
sending a subscription request for subscribing the change information of the satellite signal coverage to the second network element.

6. The method according to claim 1, wherein determining whether to perform the service communication with the UE according to the satellite coverage information comprises:
performing the service communication with the UE when determining, according to the satellite coverage information, that the area where the UE is located is covered by satellite signals.

7. The method according to claim 6, wherein performing the service communication with the UE comprises:
performing a service authorization request to a second network element; and
determining to start the service communication with the UE when receiving a service authorization success instruction sent by the second network element.

8. The method according to claim 1, wherein the first network element comprises an application function (AF).

9. The method according to claim 1, wherein the area where the UE is located comprises:
a tracking area (TA) where the UE is located,
or
a satellite cell where the UE is located.

10. A method for service communication control, performed by a second network element, comprising:
sending satellite coverage information of an area where a user equipment (UE) is located to a first network element, wherein the satellite coverage information is used by the first network element to perform service communication with the UE when the area where the UE is located is covered by satellite signals.

11. The method according to claim 10, wherein the satellite coverage information comprises:
time period information of satellite signal coverage in the area where the UE is located,
or
change information of the satellite signal coverage of the area where the UE is located.

12. The method according to claim 10, further comprising:
receiving a subscription request sent by the first network element; and
sending the satellite coverage information of the area where the UE is located to the first network element comprises:
after receiving the subscription request, sending change information of satellite signal coverage of the area where the UE is located to the first network element when the satellite signal coverage of the area where the UE is located changes.

13. The method according to claim 11, wherein the time period information of the satellite signal coverage comprises at least one of:
start time information and duration information when the area where the UE is located is covered by the satellite signals; or start time information and end time information when the area where the UE is located is covered by the satellite signals; or
start time information and duration information when the area where the UE is located is not covered by the satellite signals; or start time information and end time information when the area where the UE is located is not covered by the satellite signals.

14. The method according to claim 11, wherein the change information of satellite signal coverage comprises at least one of:
first change information, indicating that the area where the UE is located changes from being covered by satellite signals to not being covered by satellite signals, or
second change information, indicating that the area where the UE is located changes from not being covered by satellite signals to being covered by satellite signals.

15. The method according to claim 10, wherein the area where the UE is located comprises:
a tracking area (TA) where the UE is located, or
a satellite cell where the UE is located.

16. The method according to claim 10, further comprising:
receiving a service authorization request sent by the first network element;
when service communication between the first network element and the UE is allowed, sending a service authorization success instruction to the first network element, wherein the service authorization success instruction is used by the first network element to determine to start the service communication with the UE.

17. (canceled)

18. (canceled)

19. A communication device, comprising:
a transceiver;
a memory storing a program; and,
one or more processors that are communicatively coupled to the transceiver and the memory.
wherein the program when executed by the one or more processors, cause the one or more processors to collectively:
obtain satellite coverage information of an area where a user equipment (UE) is located; and
determine whether to perform service communication with the UE according to the satellite coverage information.

20. A non-transitory computer storage medium storing an executable program that when executed by a processor of the first network element, cause the first network element to perform the method according to claim 1.

21. A communication device, comprising:
a transceiver;
a memory storing a program; and
one or more processors that are communicatively coupled to the transceiver and the memory, wherein program when executed by the one or more processors cause the one or more processors to collectively perform the method according to claim 10.

22. The method according to claim 2, wherein the second network element comprises a policy control function (PCF).
